(19) United States
(12) Patent Application Publication
(10) Pub. No.: US 2006/0269470 A1
(43) Pub. Date: Nov. 30, 2006

(54) Methods and devices for hydrogen generation from solid hydrides

(76) Inventors: Qinglin Zhang, Manalpan, NJ (US); Ian Eason, Hillsborough, NJ (US); Keith A. Fennimore, Columbus, NJ (US); John Spallone, Danbury, CT (US)

Correspondence Address: DICKSTEIN SHAPIRO LLP, 1825 EYE STREET NW, Washington, DC, 20006-5403, US

(21) Appl. No.: 11/434,766

(22) Filed: May 17, 2006

Related U.S. Application Data
(63) Continuation-in-part of application No. 11/105,549, filed on Apr. 14, 2005.
(60) Provisional application No. 60/647,394, filed on Jan. 28, 2005.
(60) Provisional application No. 60/562,132, filed on Apr. 14, 2004.

(51) Int. Cl. H01M 8/06

(52) U.S. Cl. 423/648.1; 48/61

(57) ABSTRACT

Hydrogen generators and power module systems that use solid chemical hydrides and acidic reagents for hydrogen storage and generation on demand are disclosed. The generators incorporate mechanisms for controlling the contact between solid chemical hydride and acidic reagents to control the rate of hydrogen generation and characteristics of the reaction products, including bulk density. The preferred systems of the present invention combine functions of fuel reagent storage, reaction chamber, and gas-liquid separation into a minimum number of components to reduce the balance of plant of hydrogen generation systems.

This application is a continuation-in-part of U.S. application Ser. No. 11/105,549, filed Apr. 14, 2005, which claims the benefit of U.S. Provisional Application Ser. No. 60/647,394, filed Jan. 28, 2005, and of U.S. Provisional Application Ser. No. 60/562,132, filed Apr. 14, 2004, the entire disclosures of all of which are incorporated herein by reference.

### FIELD OF THE INVENTION

The present invention relates to the generation of hydrogen from a fuel that is stored in solid form and from which hydrogen is generated using an acidic reagent.

### BACKGROUND OF THE INVENTION

Hydrogen is the fuel of choice for fuel cells. However, its widespread use can be complicated by the difficulties in storing the gas. Many hydrogen carriers, including hydrocarbons, metal hydrides, and chemical hydrides are being considered as hydrogen storage and supply systems. In each case, systems need to be developed in order to release the hydrogen from its carrier, either by reformation as in the case of hydrocarbons, desorption from metal hydrides, or catalyzed hydrolysis of chemical hydrides.

Complex chemical hydrides, such as sodium borohydride and lithium borohydride, have been investigated as hydrogen storage media. The gravimetric hydrogen storage density of sodium borohydride is 10.8% and lithium borohydride is 18%. Sodium borohydride has garnered particular interest, because it can be dissolved in alkaline water solutions with virtually no reaction; hydrogen is not generated until the solution contacts a catalyst to promote hydrolysis. In a typical heterogeneous catalyzed system, the stoichiometric reaction of borohydrides with water to produce hydrogen gas and a borate is illustrated by the following chemical reaction:
MBH₄+2H₂O→MBO₂+4H₂+heat (1)

Generators that utilize a metal borohydride fuel solution and a heterogeneous catalyst system typically require at least three chambers, one each to store fuel and borate product, and a third chamber containing the catalyst. Hydrogen generation systems can also incorporate additional balance of plant (“BOP”) components such as hydrogen ballast tanks, heat exchangers, condensers, gas-liquid separators, filters, and pumps.

Another limitation in the use of fuel solutions relates to the shelf life of the liquid fuel. The liquid fuel is stable at temperatures below 40° C., which is sufficient for those applications which consume fuel in an ongoing manner. However, hydrogen can evolve as the temperature increases. Excessive hydrogen accumulation in the fuel storage chamber is particularly undesirable in applications such as consumer electronics.

Further, to maintain the borohydride and borate solids in solution, an amount of water is required beyond that needed for the stoichiometric reaction, since water is typically removed from the system by the formation of hydrated borate compounds as depicted by equation (2) below:
MBH₄+4H₂O→MBO₂.2H₂O+4H₂+heat (2)

In addition, liquid water can be lost during the reaction to vaporization. Extra water may be added to the system to compensate for this loss, such as by using a dilute borohydride fuel solution. All of these factors, however, contribute to water/borohydride molar ratios significantly greater than 4:1 for practical hydrogen generation systems based on hydrolysis of borohydride fuel solutions, and this excess water limits the effective hydrogen storage density of such hydrogen generation systems.

Systems for hydrogen generation based on solid chemical hydrides typically involve introducing water to a bed of a reactive hydride for hydrolysis. Such uncatalyzed systems are limited to the more reactive chemical hydrides, such as sodium hydride, lithium hydride, and calcium hydride. For borohydride compounds, the simple reaction with water is slow and either a heterogeneous catalyst is incorporated into the mixture, or the solid is used for storage and is then converted into a liquid fuel for hydrogen generation.

### BRIEF SUMMARY OF THE INVENTION

The present invention provides apparatus for hydrogen generation by the acid catalyzed hydrolysis of a solid fuel. In a preferred embodiment, the apparatus include a solid fuel storage region, a reaction chamber adapted to contain at least one acidic reagent capable of generating hydrogen upon contact with the solid fuel in the presence of water, and means for contacting the solid fuel with the acidic reagent in the reaction chamber to produce hydrogen gas and a product having a bulk density of at least about 0.7 g/cc. The apparatus further include a hydrogen outlet line in communication with the reaction chamber, and a hydrogen separator adapted to prevent solids and liquids in the reaction chamber from entering the hydrogen outlet line.

In another embodiment, apparatus are provided for hydrogen generation by the hydrolysis of a solid fuel, including a storage area adapted to contain an acidic reagent, a reaction chamber adapted to contain a solid fuel capable of generating hydrogen upon contact with the acidic reagent in the presence of water, and means for contacting the acidic reagent with the solid fuel in the reaction chamber to produce hydrogen gas and a product having a bulk density of at least about 0.7 g/cc. The preferred embodiments are capable of producing borate products which sequester little or no water.

In another embodiment, apparatus are provided for hydrogen generation by the hydrolysis of a solid fuel including a reaction chamber having an acidic reagent storage area adapted to contain an acidic reagent and a solid fuel storage region for containing a solid fuel capable of generating hydrogen upon contact with the acidic reagent in the presence of water, a moveable partition within the reaction chamber separating the acidic reagent and solid fuel storage areas within the reaction chamber, and means for contacting the acidic reagent with the solid fuel in the reaction chamber to produce hydrogen gas and a product, wherein movement of the partition exposes at least a portion of a hydrogen separator on an inner wall of the reaction chamber to reaction product in the reaction chamber. The reaction chamber may further comprise an outer wall to permit storage of hydrogen between the inner and outer walls.

The present invention further provides methods of generating hydrogen gas by a hydrolysis reaction, utilizing a solid fuel capable of generating hydrogen and a product when contacted with an acidic reagent in the presence of water. An acidic reagent is provided, and the acidic reagent and the solid fuel are contacted in a reaction chamber, wherein such contact generates hydrogen gas and a product having a bulk density of at least about 0.7 g/cc.

The present invention further provides methods of generating hydrogen gas by a hydrolysis reaction, utilizing a solid fuel capable of generating hydrogen and a borate product when contacted with an acidic reagent in the presence of water. An acidic reagent is provided, and the acidic reagent and the solid fuel are contacted in a reaction chamber, wherein such contact generates hydrogen gas and a product having a bulk density of at least about 0.7 g/cc, wherein movement of a moveable partition in the reaction chamber exposes one or more hydrogen separator membranes or portions of such membranes to the hydrogen gas and product in the reaction chamber.

In another embodiment, the present invention provides methods of operating a power module, by providing a power module having a hydrogen gas inlet in communication with a hydrogen gas outlet of an associated hydrogen generator. A solid fuel capable of generating hydrogen and a product when brought into contact with an acidic reagent and water is provided. The acidic reagent and the solid fuel are contacted under conditions wherein such contact generates hydrogen gas and a product having a bulk density of at least about 0.7 g/cc. In a preferred embodiment, water generated as a product in the fuel cell power module is transported back to the reaction chamber of the hydrogen generator.

The accompanying drawings together with the detailed description herein illustrate these and other embodiments and serve to explain the principles of the invention. Other features and advantages of the present invention will also become apparent from the following description of the invention which refers to the accompanying drawings.

### BRIEF DESCRIPTION OF THE DRAWINGS

FIG. 1 is a schematic illustration of a hydrogen generator system in accordance with the present invention with a solid fuel storage area, a solid fuel dispensing system, and a reaction chamber.

FIG. 2 is a schematic illustration of a hydrogen generator system in accordance with the present invention with a liquid reagent storage area, a liquid reagent dispensing system, and a reaction chamber.

FIG. 3 is a schematic illustration of a hydrogen generator system in accordance with the present invention with a liquid reagent storage area, a liquid reagent dispensing system, and a reaction chamber, wherein the liquid reagent storage area and the reaction chamber are separated by a moveable partition.

### DETAILED DESCRIPTION OF THE INVENTION

The present invention provides acid hydrolysis systems and methods which convert solid chemical hydride fuel to hydrogen. Multiphase reactions in which an aqueous acid solution directly contacts a solid chemical hydride to produce a solid or slurry product can provide advantages over heterogeneous reactions involving an aqueous chemical hydride solution and a solid catalyst. For instance, the effective energy density may be increased by eliminating both the inherent concentration limit and the discrete catalyst bed which are present in liquid fuel based systems. Furthermore, certain embodiments of the systems of the present invention utilize reaction chambers that also function as heat-exchangers, hydrogen ballast tanks, and/or gas-liquid-solid separators, so as to minimize BOP and system complexity. In addition, the overall BOP is reduced since a discrete catalyst bed is not necessary.

To maximize the storage density, it is preferable to utilize water (H₂O) to borohydride ion (BH₄⁻) molar ratio approaching the room-temperature stoichiometric limit of 2:1. When an acid solution is used in place of a solid heterogeneous catalyst system, the conjugate base of the acid is incorporated into the borate product, which according to preferred aspects of the present invention can result in a reduced amount of hydrated borate salts and thus sequester less water. Further, it is now possible to control the physical state, e.g. liquid or solid, of the reaction products. Liquid reaction products enable easy removal of the products from the generator, while solids can result in improved energy storage density, due to the reduced need for excess water.

The preferred chemical hydride fuel components for acid catalyzed hydrolysis according to the present invention are boron hydrides in solid form. Boron hydrides as used herein include boranes, polyhedral boranes, and anions of borohydrides or polyhedral boranes, such as those disclosed in co-pending U.S. patent application Ser. No. 10/741,199, entitled “Fuel Blends for Hydrogen Generators,” the content of which is hereby incorporated herein by reference in its entirety. Suitable boron hydrides include, without intended limitation, neutral borane compounds such as decaborane (14) (B₁₀H₁₄); ammonia borane compounds of formula NHₓBH_{y} and NHₓRBH_{y}, wherein x and y independently=1 to 4 and do not have to be the same, and R is a methyl or ethyl group; borazane (NH₃BH₃); the group of borohydride salts M(BH₄)ₙ, triborohydride salts M(B₃Hₛ)ₙ, decahydrodecaborate salts M₂(B₁₀H₁₀)ₙ, tridecahydrodecaborate salts M(B₁₀H₁₃)ₙ, dodecahydrododecaborate salts M₂(B₁₂H₁₂)ₙ, and octadecahydroicosaborate salts M₂(B₂₀H₁₈)ₙ, wherein M is selected from the group consisting of alkali metal cations, alkaline earth metal cations, aluminum cation, zinc cation, and ammonium cation, and n corresponds to the charge of the selected M cation; M is preferably sodium, potassium, lithium, or calcium. These chemical hydrides may be utilized in mixtures or individually. Preferred for such systems in accordance with the present invention are the metal borohydrides having the general formula M(BH₄)ₙ, Examples of such compounds include, without intended limitation, NaBH₄, KBH₄, LiBH₄, and Ca(BH₄)₂. Particularly preferred for systems in accordance with the present invention is NaBH₄.

The term “solid form” encompasses any dry or substantially dry form, including powder, granules or pellets.

The chemical hydride may be anhydrous or hydrated and preferably contains less than about 50 wt % water. The hydrated forms of certain borohydride salts, notably sodium borohydride, exist at low to moderate temperatures. For example, sodium borohydride dihydrate (NaBH₄.2H₂O, 51.2 wt % NaBH₄ and 48.8 wt % water) is formed at temperatures below 36.4° C., potassium borohydride trihydrate exists at temperatures below 7.5° C., and potassium borohydride monohydrate exists at temperatures below 37.5° C.

The solid metal borohydride fuel component may be combined with a solid stabilizer agent, preferably one selected from the group consisting of metal hydroxides, anhydrous metal metaborates, hydrated metal metaborates, and mixtures thereof. Examples of suitable stabilized fuel compositions comprising borohydride and hydroxide salts are disclosed in co-pending U.S. patent application Ser. No. 11/068,838 entitled “Borohydride Fuel Composition and Methods,” filed on Mar. 2, 2005, the disclosure of which is incorporated by reference herein in its entirety.

Hydrogen generation systems according to the present invention generate hydrogen by contacting a chemical hydride fuel with an acidic reagent. The fuel may be a complex metal hydride, e.g., sodium borohydride (NaBH₄), which is stored in solid form. Mixtures of complex metal hydrides can be used to maximize solubility of the resulting borate product. For example, mixtures of KBH₄ and NaBH₄ form eutectic-like phases and may be employed to result in soluble borate salt products. The acidic reagent, i.e., a reagent having a pH less than about 7, may be in an aqueous solution or may be in solid form, the latter requiring the presence of water to transform the solid complex chemical hydride fuel into hydrogen and a metal borate (“product” or “discharged fuel”).

Suitable acidic reagents include, but are not limited to, inorganic acids such as the mineral acids hydrochloric acid (HCl), sulfuric acid (H₂SO₄), and phosphoric acid (H₃PO₄), and organic acids such as acetic acid (CH₃COOH), formic acid (HCOOH), maleic acid, citric acid, and tartaric acid, among others. The acidic reagents may also comprise a combination of organic and/or inorganic acids. Different acids have different characteristics such as solution density and viscosity so the choice of acid may be different for various applications. Preferably, the acidic reagent is a solution containing the acidic reagent in a range from about 0.1 to about 40 wt %. In some embodiments, the acidic reagent is an aqueous solution with a water concentration in the range of about 44 to 52 molar (M) water, preferably about 46 to 50 M water and most preferably about 48 M water (in comparison, pure water can be considered to have a water concentration of 55 M water) and has a pH less than 7.

A secondary water soluble co-catalyst such as a transition metal catalyst, for example, the chloride salts of cobalt (CoCl₂), nickel (NiCl₂), or copper (CuCl₂), may be optionally added to the acid solution to further catalyze the reaction. In such cases, as the reagent solution contacts the borohydride, the metal ion is typically reduced by the borohydride and deposited as metal particles or metal boride compounds in the solid borohydride contained within the reaction chamber. These materials can accumulate within the reaction chamber as the borohydride is consumed. Since these materials can also catalyze hydrolysis of borohydride, the increased concentration of metal catalyst with increased time of operation ensures that the borohydride fuel is completely converted to hydrogen.

Preferred embodiments of the present invention provide hydrogen generation systems in which a chemical borohydride compound in solid form is stored in the vicinity of an aqueous solution of the acidic reagent. Hydrogen is generated by bringing the stored compounds into contact with one another to produce hydrogen and borate products. The rate of hydrogen generation can be regulated by controlling the contact between the acidic reagent and the solid chemical hydride. The hydrogen generation reaction can be stopped by preventing contact between the acidic reagent and the solid chemical hydride.

Hydrogen generation by the acid hydrolysis of borohydrides occurs as shown in the following equations, for a metal borohydride compound and hydrochloric acid
4MBH₄+2HCl+12H₂O→M₂B₄O₇.5H₂O+16H₂+2MCl (3)
4MBH₄+2HCl+17H₂O→M₂B₄O₇.10H₂O+16H₂+2MCl (4)
MBH₄+HCl+3H₂O→H₃BO₃+4H₂+MCl (5)

For those fuels that include a basic stabilizer agent, a portion of the acidic reagent may neutralize the stabilizer agent. An example of the neutralization reaction is shown for NaOH in equation (6):
NaOH+HCl→H₂O+NaCl (6)

As shown in equations (3), (4) and (5), borate compounds with varying numbers of associated water molecules can be formed depending on conditions within the reaction chamber. To maximize the conversion of water to hydrogen, it is preferred that less hydrated borate products are predominately produced to prevent sequestration of the water by the borate products and to ensure that the maximum amount of stored water is available for hydrogen generation. By “predominately” herein we mean that more than 50% by weight, preferably more than 75% and more preferably more than 90%, of the borate product is present as one or more of the preferred borates. For example, borates such as M₂B₄O₇.10H₂O, M₂B₄O₇.5H₂O, and H₃BO₃ with B/H₂O ratios of 2:5, 4:5 and 1:0, respectively, are formed by the reaction of hydrochloric acid with solid sodium borohydride. These compounds sequester less water on a per boron atom basis than the borate compounds typically produced by hydrolysis of a fuel solution, and thus reduce the demand for additional water. The state of discharged fuel and distribution of products can be further controlled by the selection of particular acidic reagents, reagent concentrations, and the ratios of acidic reagent to solid chemical hydride. It is preferred that the boron-containing products contain no or few water molecules so that water provided with the acidic reagent can be utilized primarily for hydrogen generation. It is also preferable to store solid chemical hydride and acidic reagents at their stoichiometric ratio to maximize fuel energy density.

Further, it is preferable that stable borate hydrate products are predominately formed. By “stable” herein we mean borate hydrate products that do not dehydrate (i.e., lose waters of hydration) below about 100° C. Preferable stable borate hydrates include borax pentahydrate (Na₂B₄O₇.5H₂O) and sodium metaborate dihydrate (NaBO₂.2H₂O). The conditions within the reaction chamber such as relative humidity, pressure, and temperature also can be used to control product distribution. For example, borax decahydrate dehydrates to borax pentahydrate, and sodium metaborate tetrahydrate dehydrates to sodium metaborate dihydrate, at temperatures from between about 50° C. and 100° C.

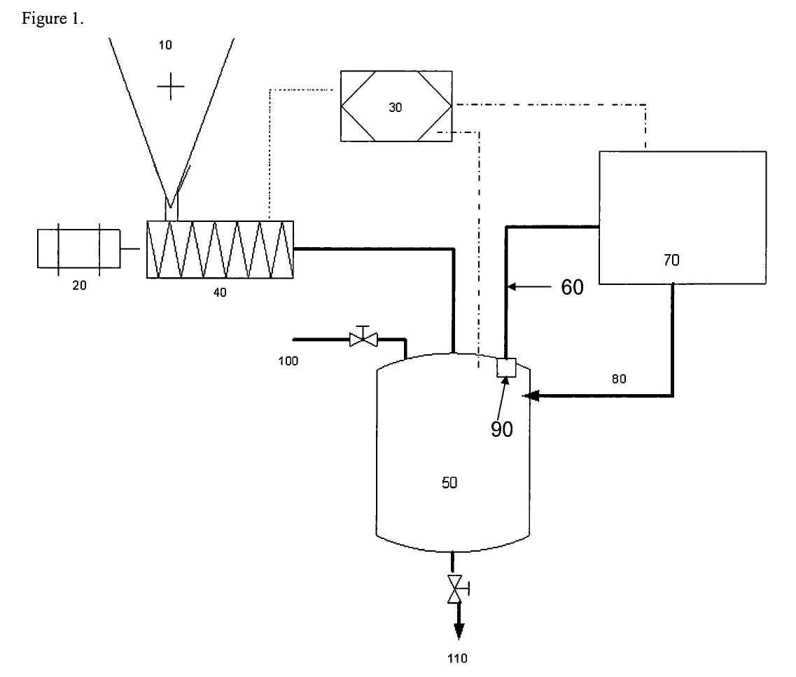

Referring now to FIG. 1, an exemplary system for hydrogen generation from the acid catalyzed hydrolysis of solid borohydride comprises a solid fuel storage region 10, a solid fuel feeding system 40 and a reaction chamber 50. The solid fuel feeding system 40 may be any suitable solids dispensing system such as, but not limited to, a screw feeder, rotary star feeder, or pellet dispenser, and may be driven by a motor 20. Additional illustrative solid dispensing systems and apparatus are disclosed in U.S. patent application Ser. No. 10/115,269, entitled “Method and System for Generating Hydrogen by Dispensing Solid and Liquid Fuel Components,” filed Apr. 2, 2002, which is incorporated by reference herein in its entirety.

The reaction chamber may be permanently or removably attached to the hydrogen generation system, and is thus either refillable or replaceable. Hydrogen outlet line 60 connects reaction chamber 50 to a power module 70 for conversion to energy comprising a fuel cell or hydrogen-burning engine, or to a hydrogen storage device, including balloons, gas cylinders or metal hydrides. A hydrogen separator 90 is in communication with hydrogen outlet line 60, and preferably precedes or is incorporated in the inlet to the hydrogen outlet line 60. Optionally, inlet line 100, outlet line 110, and inlet line 80 may be connected to reaction chamber 50 to supply additional reagents or to remove reaction products. At least one controller 30 can be included within the system to control the hydrogen generation system and the power module or other hydrogen device. Illustrative examples of such a controller include programmable logic control (PLC) circuits, microcontrollers, and microprocessors.

The dispensing of solid fuel to the reaction chamber 50 containing the acidic reagents can be controlled by monitoring and using the gas pressure in the system or reaction chamber, power demand of the fuel cell, temperature of the reaction chamber, the level of materials in the reaction chamber, or a combination of these factors as a control signal. For example, when the system hydrogen pressure is used as a control signal, as hydrogen is consumed, the system pressure drops below a set point and the controller can increase the rate of solid fuel dispensing. When the system pressure reaches the set point, i.e., when the demand for hydrogen is low, the solid fuel dispenser can be stopped to shut down hydrogen generation.

The initial reaction between the solid fuel and the acidic reagent is typically rapid. As the reaction between the two components progresses and the acidic reagent is consumed, the rate of hydrogen generation may decrease. To minimize the formation of foam in the reaction chamber, it is preferable to operate the reaction chamber at relatively high pressures, preferably in a range of between about 10 psig to about 200 psig, more preferably between about 50 to about 180 psig to suppress foaming.

In one embodiment, the reaction chamber serves as a hydrogen ballast tank and stores hydrogen to supply the demand of the power module or other hydrogen device during startup of the hydrogen generation system by storing hydrogen, either generated from residual fuel components after the solid fuel feed is stopped, or hydrogen previously unconsumed by the hydrogen device.

The hydrogen generated in the reaction chamber passes through a separator 90 to separate the hydrogen gas and maintain solids and liquids within the reaction chamber 50. Hydrogen is delivered via a hydrogen outlet line 60 using, for example, a pressure regulator, flow controller, or valve to control the flow, for use by the hydrogen device. The separator may be a hydrogen permeable membrane or filter. Suitable gas permeable membranes include materials that are more permeable to hydrogen than a liquid such as water, such as silicon rubber, polyethylene, polypropylene, polyurethane, fluoropolymers or any hydrogen-permeable metal membranes, such as palladium-gold alloys; preferably the hydrogen separation membrane is hydrophobic.

The system is illustratively shown in FIG. 1 with a fuel cell (70). The fuel cell may be any type of fuel cell that consumes hydrogen gas, such as a PEM fuel cell, a solid oxide fuel cell (SOFC), or an alkaline fuel cell (AFC). The fuel cell is equipped with a hydrogen inlet and an air inlet (not shown) to intake the gaseous components necessary for electricity generation per equation (7) below, as is typical for PEM fuel cells:
2H₂+O₂→2H₂O+e⁻ (7)

As shown in equation (7), a product of electricity generation is water. In a closed system, the water can be recovered from the fuel cell and transported via optional conduit 80 to reaction chamber 50. This water can be added to the acidic reagent present in reaction chamber 50 for reaction with the solid chemical hydride. Recycle of fuel cell water allows the system to be initially charged with a concentrated acidic reagent solution to reduce the weight and volume of the acidic reagent, and increase the system energy storage density.

After all the solid fuel has been consumed, a solvent such as water can be added through inlet 100 to dissolve the reaction products and aid in the discharge of reaction products through line 110. Likewise, water from the fuel cell can be added via inlet 80 to help wash products from the reaction chamber 50.

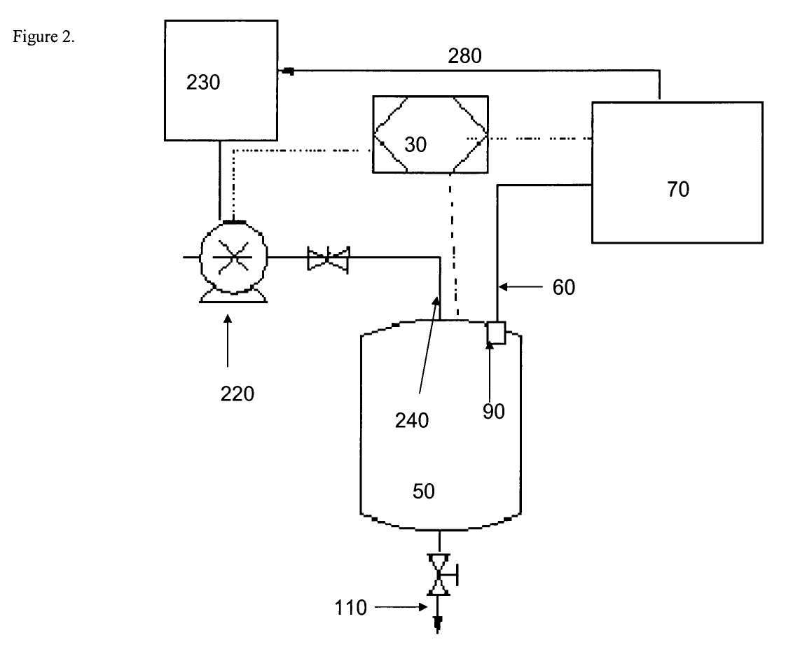

Referring to FIG. 2, wherein features that are similar to those shown in FIG. 1 have like numbering, hydrogen is generated on demand by conveying an acidic reagent from a storage area 230 using an acidic reagent regulator 220 through conduit 240 to a reaction chamber 50 containing a solid fuel. Acidic reagent regulator 220 may comprise, for example, pumps including, but not limited to, peristaltic pumps, piezoelectric pumps, piston pumps, diaphragm pumps, centrifugal pumps, and axial flow pumps, or valves including, but not limited to, solenoid valves, ball valves, pinch valves, and diaphragm valves.

The reaction chamber may be permanently or removably attached to the hydrogen generation system, and is thus either refillable or replaceable. Hydrogen outlet 60 connects reaction chamber 50 to a power module 70 comprising a fuel cell or hydrogen-burning engine, or to a hydrogen storage device, including balloons, gas cylinders or metal hydrides. A hydrogen separator 90 is in communication with hydrogen outlet line 60, and preferably precedes or is incorporated in the inlet to the hydrogen outlet line 60. Optionally, an outlet line 110, and an inlet line 80 (not shown) may be connected to reaction chamber 50 to supply additional reagents or to remove reaction products. Some configurations may utilize multiple outlet lines 110, conduits 240, and/or inlet lines 80 to accelerate the addition or removal of materials to the reaction chamber 50. At least one controller 30 can be included within the system to control the hydrogen generation system and the hydrogen device. Illustrative examples of such a controller include programmable logic control (PLC) circuits, microcontrollers, and microprocessors.

Hydrogen generation may be controlled by the amount and rate of addition of the acidic reagent to the solid hydride fuel in reaction chamber 50. As described previously, monitoring parameters such as gas pressure in the system, temperature of the reaction chamber, the level of materials in the reaction chamber, or power demand of the fuel cell can be used to control acidic reagent regulator 220.

Water generated by the hydrogen fuel cell may be recycled via line 280 to storage tank 230 where the recycled water can combine with and dilute the acidic reagent stored in tank 230. Alternatively, the line 280 may connect directly to conduit 240 to allow in-line dilution of the acidic reagent as it is provided to the reaction chamber 50. Recycle of fuel cell water allows the system to be initially charged with a concentrated acidic reagent solution to reduce the weight and volume of acidic reagent and increase system energy storage density. A separate water source (not illustrated) may be present within the hydrogen generator to allow for dilution of the acidic reagent when water from the fuel cell is unavailable, for example, prior to electricity generation or if the water is used to maintain humidification of the polymer electrolyte membrane of the fuel cell.

After all of the solid fuel has been consumed, a solvent such as water can be added into storage tank 230 and into the reactor chamber 50 via inlet 240 to dissolve the reaction products and aid in the discharge of reaction products through line 110. Likewise, water from the fuel cell can be added via inlet 80 (not shown) to help wash products from the chamber.

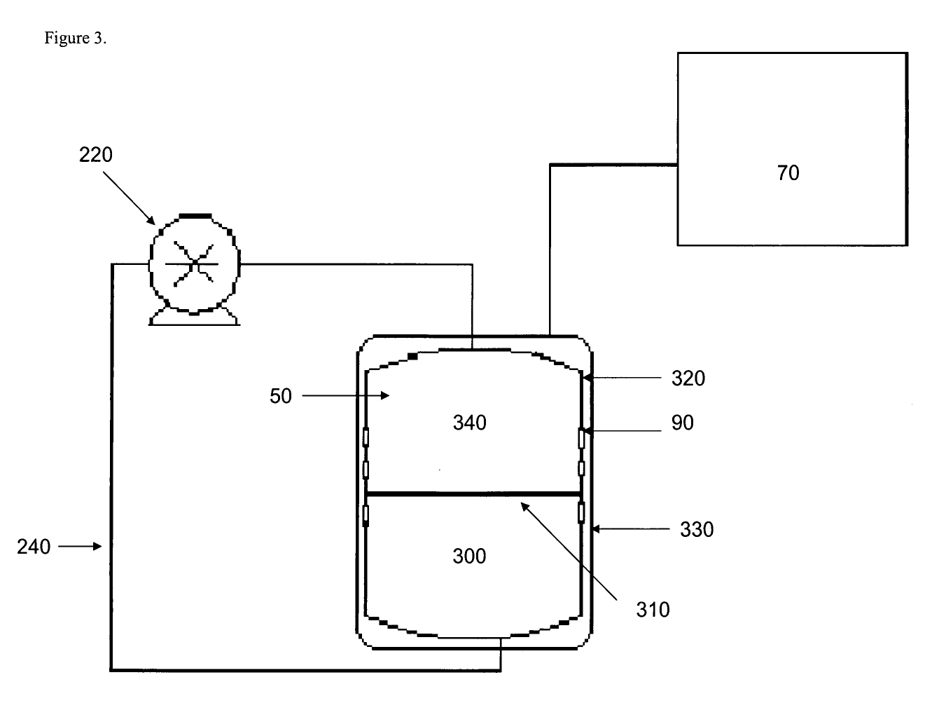

Referring to FIG. 3, wherein features that are similar to those shown in FIG. 1 have like numbering, reaction chamber 50 includes an inner wall 320 and further comprises a moveable wall 310 to partition reaction chamber 50 into a first region 300, where solid fuel is stored and hydrolysis takes place and a second region 340, where an acidic reagent is stored. Inner wall 320 contains at least one hydrogen separator 90 located so that at least a first portion of hydrogen separator 90 is initially present in the second region 340 and is exposed to product in the first region 300 as the volume of the first region 300 increases by movement of wall 310 toward the second region as the acidic reagent is conveyed out of that region. Conversely, the first region may be configured to contain an acidic reagent where the hydrolysis reaction takes place and the second region may be configured to store a solid fuel, which is conveyed to the first region. A single separator 90 or multiple separators 90 may be present and located along the length of inner wall 320 depending on the available surface area of inner wall 320. In this manner, at least portions of one or more hydrogen separators are prevented from constant exposure to conditions of the hydrolysis reaction, and the solid fuel and liquid reagent are arranged in a volume exchanging configuration. The reaction chamber 50 further comprises an outer housing 330 forming a gas storage region between the wall of outer housing 330 and the inner wall 320.

Hydrogen is generated as needed by conveying an acidic reagent from the second region 340 through conduit 240 using an acidic reagent regulator 220 to a first region 300 containing a solid fuel within reaction chamber 50. The acidic reagent is preferably contained in a flexible liner within the second region 340 which can decrease in volume as the acidic reagent is fed to the first region 300 within reaction chamber 50. Acidic reagent regulator 220 may comprise, for example, pumps including, but not limited to, peristaltic pumps, piezoelectric pumps, piston pumps, diaphragm pumps, centrifugal pumps, and axial flow pumps, or valves including, but not limited to, solenoid valves, ball valves, pinch valves, and diaphragm valves.

The following examples further describe and demonstrate features of methods and systems for hydrogen generation and control according to the present invention. The examples are given solely for illustration purposes and are not to be construed as limitations of the present invention. Various other approaches within the scope of the appendent claims will be readily ascertainable to one skilled in the art given the teachings herein.

### EXAMPLE 1

H₂ flow rates were measured in a semi-batch reactor system with about 5 g of solid granular sodium borohydride loaded in a 250 mL Pyrex reactor. Acidic reagents as shown in Table 1 were fed by a syringe pump to the reactor. The rate of hydrogen production was recorded using an on-line mass flow meter. The total amount of hydrogen generated in each run was established by numerical integration of dynamic hydrogen flow profile. After each run, reaction products in the reactor were collected for bulk density measurements and NMR analysis. Sodium borohydride conversion was analyzed using NMR of the post-reaction mixture after each run was completed.

TABLE 1
Hydrogen generation from pure sodium borohydride

| Acid concentration | Weight ratio | Molar ratio | | Conversion | Energy density* | | Bulk Density |
|---|---|---|---|---|---|---|---|
| wt % | Acid:fuel | H₂O:NaBH₄ | H⁺:NaBH₄ | % | Wh/kg | State | g/mL |

HCl

| | | | | | | | |
|---|---|---|---|---|---|---|---|
| 15 | 2.6 | 5.27 | 0.46 | 100 | 996 | slurry | 0.78 |
| 20 | 3.0 | 5.09 | 0.64 | 100 | 882 | slurry | 1.60 |
| 37 | 2.4 | 3.15 | 0.93 | 98 | 1023 | solid | 0.73 |

H₂SO₄

| | | | | | | | |
|---|---|---|---|---|---|---|---|
| 25 | 2.94 | 4.62 | 0.57 | 100 | 901 | slurry | 1.61 |

*Based on fuel (NaBH₄ and acid) only and a fuel cell efficiency of 50%

Reaction of 5 g of solid NaBH₄ with 15 wt % HCl led to formation of borax decahydrate as the primary product; increasing the acid concentration to about 20 wt % HCl led to formation of borax pentahydrate as the main product. A similar product distribution was noted for 25 wt % sulfuric acid. At higher concentrations of HCl, e.g., 37 wt %, boric acid was the major product. High fuel energy storage density over 1000 Wh/Kg was achieved (Table 1) with use of the near stoichiometric molar ratio of the reagents (3 moles of H₂O per mole of borohydride and a one to one molar ratio between proton (H⁺) and borohydride). Products with higher bulk densities typically require less space for storage.

### EXAMPLE 2

Using the procedures described in Example 1, hydrogen was generated using 5.75 g of a mixture of sodium borohydride (87 wt %) and sodium hydroxide (13 wt %). Results are summarized in Table 2.

TABLE 2
Hydrogen generation from sodium hydroxide stabilized sodium borohydride (87/13 wt/wt NaBH₄/NaOH)

| Acid concentration | Weight ratio | Molar ratio | | Conversion | Energy density* | | Bulk Density |
|---|---|---|---|---|---|---|---|
| wt % | Acid:fuel | H₂O:NaBH₄ | H⁺:NaBH₄ | % | Wh/kg | State | g/mL |

HCl

| | | | | | | | |
|---|---|---|---|---|---|---|---|
| 22 | 2.6 | 4.9 | 0.70 | 95 | 809 | solid | 1.08 |
| 24 | 2.7 | 5.0 | 0.78 | 97 | 813 | solid | 1.16 |
| 37 | 2.8 | 4.3 | 1.27 | 99 | 795 | solid | 0.73 |

H₂SO₄

| | | | | | | | |
|---|---|---|---|---|---|---|---|
| 25 | 2.7 | 4.9 | | 97 | 813 | solid | 1.02 |
| 27 | 2.8 | 5.0 | | 100 | 809 | slurry | 1.21 |
| 25 | 2.6 | 4.8 | 0.58 | 97 | 825 | slurry | 1.02 |
| 27 | 2.8 | 4.9 | 0.66 | 100 | 823 | solid | 1.21 |

*Based on fuel (NaBH₄ and acid) only and a fuel cell efficiency of 50%

The above description and drawings are only to be considered illustrative of exemplary embodiments, which achieve the features and advantages of the invention. Modification and substitutions to specific process conditions and structures can be made without departing from the spirit and scope of the invention. Accordingly, the invention is not to be considered as being limited by the foregoing description and drawings, but is defined by the scope of the appended claims.

What is claimed as new and desired to be protected by Letters Patent is:

1. An apparatus for hydrogen generation by the acid catalyzed hydrolysis of a solid fuel, comprising:
a solid fuel storage region;
a reaction chamber adapted to contain at least one acidic reagent capable of generating hydrogen upon contact with the solid fuel in the presence of water;
a means for contacting the solid fuel with the acidic reagent in the reaction chamber to produce hydrogen gas and a product;
a hydrogen outlet line in communication with the reaction chamber; and
a hydrogen separator adapted to prevent solids and liquids in the reaction chamber from entering the hydrogen outlet line.

2. The apparatus of claim 1, wherein the means for contacting further comprises a solid fuel dispenser for delivering solid fuel from the storage region to the reaction chamber.

3. The apparatus of claim 2, wherein the solid fuel dispenser comprises a screw feeder, rotary star feeder, or a pellet dispenser.

4. The apparatus of claim 1, wherein the acidic reagent has a water concentration of about 48 M.

5. The apparatus of claim 2, further comprising a controller for controlling the dispensing of the solid fuel from the solid fuel dispenser.

6. The apparatus of claim 5, wherein the controller is configured to use as a control signal at least one of gas pressure in the reaction chamber, temperature of the reaction chamber, the level of materials in the reaction chamber, and power demand of a power module.

7. The apparatus of claim 6 wherein the power module is selected from the group consisting of a fuel cell and a hydrogen-burning engine.

8. The apparatus of claim 6, wherein the power module is selected from the group consisting of a PEM fuel cell, a solid oxide fuel cell, and an alkaline fuel cell.

9. The apparatus of 6 further comprising a conduit configured to transport water generated as a product in the power module from the power module to the reaction chamber.

10. The apparatus of claim 1, further comprising at least one inlet line configured to supply a reagent to the reaction chamber.

11. The apparatus of claim 1, wherein the reaction chamber is permanently attached to the hydrogen generator apparatus.

12. The apparatus of claim 1, wherein the reaction chamber is removably attached to the hydrogen generator apparatus.

13. The apparatus of claim 1, wherein the reaction chamber is configured to store hydrogen.

14. The apparatus of claim 1, wherein the hydrogen separator comprises at least one of a hydrogen permeable membrane or a filter.

15. The apparatus of claim 14, wherein the hydrogen permeable membrane is hydrophobic.

16. The apparatus of claim 14, wherein the hydrogen permeable membrane comprises a material selected from the group consisting of silicon rubber, polyethylene, polypropylene, polyurethane, fluoropolymer, and hydrogen-permeable metal.

17. The apparatus of claim 1, wherein the reaction chamber is partitioned by a moveable wall.

18. The apparatus of claim 17, wherein the reaction chamber further comprises inner and outer walls.

19. The apparatus of claim 18, wherein the inner wall comprises at least one hydrogen separator.

20. The apparatus of claim 19, wherein at least a portion of the at least one hydrogen separator is located in the area traversed by movement of the movable partition.

21. The apparatus of claim 18, wherein the hydrogen outlet is disposed in the outer wall of the reaction chamber.

22. An apparatus for hydrogen generation, comprising:
a storage region adapted to contain an acidic reagent;
a reaction chamber adapted to contain a solid fuel capable of generating hydrogen upon contact with the acidic reagent in the presence of water;
a means for contacting the acidic reagent with the solid fuel in the reaction chamber to produce hydrogen gas and a product;
a hydrogen outlet line in communication with the reaction chamber; and
a hydrogen separator adapted to prevent solids and liquids in the reaction chamber from entering the hydrogen outlet line.

23. The apparatus of claim 22, wherein the reaction chamber is partitioned by a moveable wall.

24. The apparatus of claim 22, wherein the means for contacting comprises a pump for conveying the acidic reagent from the storage region to the reaction chamber.

25. The apparatus of claim 24, wherein the pump is selected from the group consisting of a peristaltic pump, a piezoelectric pump, a piston pump, a diaphragm pump, a centrifugal pump, and an axial flow pump.

26. The apparatus of claim 22, wherein the means for contacting comprises a valve to control the conveyance of the acidic reagent from the storage region to the reaction chamber.

27. The apparatus of claim 26, wherein the valve is selected from the group consisting of a solenoid valve, a ball valve, a pinch valve, and a diaphragm valve.

28. The apparatus of claim 22, wherein the acidic reagent has a water concentration of about 48 M.

29. The apparatus of claim 22, further comprising a controller for controlling the conveying of the acidic reagent from the acidic reagent storage region to the reaction chamber.

30. The apparatus of claim 29, wherein the controller is configured to use as a control signal at least one of gas pressure in the reaction chamber, temperature of the reaction chamber, the level of materials in the reaction chamber, and power demand of a power module.

31. The apparatus of claim 30, wherein the power module is selected from the group consisting of a fuel cell and a hydrogen-burning engine.

32. The apparatus of claim 30, wherein the power module is selected from the group consisting of a PEM fuel cell, a solid oxide fuel cell, and an alkaline fuel cell.

33. The apparatus of claim 22, further comprising at least one inlet line configured to supply a reagent to the reagent storage region.

34. The apparatus of claim 22, further comprising at least one outlet line configured to remove reaction products from the reaction chamber.

35. The apparatus of claim 22, wherein the reaction chamber is permanently attached to the hydrogen generator apparatus.

36. The apparatus of claim 22, wherein the reaction chamber is removably attached to the hydrogen generator apparatus.

37. The apparatus of claim 22, wherein the reaction chamber is configured to store hydrogen.

38. The apparatus of claim 22, wherein the hydrogen separator comprises at least one of a hydrogen permeable membrane or a filter.

39. The apparatus of claim 38, wherein the hydrogen permeable membrane is hydrophobic.

40. The apparatus of claim 38, wherein the hydrogen permeable membrane comprises a material selected from the group consisting of a silicon rubber, polyethylene, polypropylene, polyurethane, fluoropolymer, and a hydrogen-permeable metal.

41. The apparatus of claim 38, wherein the hydrogen-permeable metal membrane comprises a palladium-gold alloy.

42. The apparatus of claim 23, wherein the reaction chamber further comprises inner and outer walls.

43. The apparatus of claim 42, wherein the inner wall comprises at least one hydrogen separator.

44. The apparatus of claim 43, wherein at least a portion of the at least one hydrogen separator is located in the area traversed by movement of the movable partition.

45. The apparatus of claim 42, wherein the hydrogen outlet is disposed in the outer wall of the reaction chamber.

46. A method of generating hydrogen gas by a hydrolysis reaction, comprising:
providing a solid fuel, wherein the solid fuel is capable of generating hydrogen and a product when contacted with an acidic reagent in the presence of water;
providing an acidic reagent; and
contacting the acidic reagent and the solid fuel in a reaction chamber, wherein such contact generates hydrogen gas and a product having a bulk density of at least about 0.7 g/cc.

47. The method of claim 46, wherein the acidic reagent has a water concentration in the range of about 44 M to 52 M.

48. The method of claim 46, wherein the acidic reagent has a water concentration in the range of about 46 M to 50 M.

49. The method of claim 46, wherein the acidic reagent has a water concentration of about 48 M.

50. The method of claim 46, wherein the product is predominately borax pentahydrate.

51. The method of claim 46, wherein the product is predominately boric acid.

52. The method of claim 46, wherein the product is a borate hydrate that is stable to dehydration at temperatures below about 100° C.

53. The method of claim 46, wherein the product has a bulk density of at least about 1.0 g/cc.

54. The method of claim 46, wherein the product is a solid.

55. The method of claim 46, comprising bringing the solid fuel from a solid fuel storage region into contact with the reagent in a reaction chamber.

56. The method of claim 46, comprising bringing the reagent from a reagent storage region into contact with the solid fuel in a reaction chamber.

57. The method of claim 46, wherein the solid fuel comprises a boron hydride selected from the group consisting of boranes, polyhedral boranes, anions of borohydrides, and anions of polyhedral boranes.

58. The method of claim 46, wherein the solid fuel comprises at least one borohydride salt of formula M(BH₄)ₙ, wherein M is selected from the group consisting of alkali metal cations, alkaline earth metal cations, aluminum cation, zinc cation, and ammonium cation, and n corresponds to the charge of the selected M cation.

59. The method of claim 58, wherein water and borohydride are provided to the reaction chamber in a molar ratio of about 4:1 to about 5.3:1.

60. The method of claim 58, wherein water and borohydride are provided to the reaction chamber in a molar ratio of about 5:1.

61. The method of claim 46, wherein the acidic reagent and solid fuel are provided to the reaction chamber in about a stoichiometric ratio

62. The method of claim 46, wherein the fuel comprises a material selected from the group consisting of sodium borohydride, lithium borohydride, potassium borohydride, and calcium borohydride, and mixtures thereof.

63. The method of claim 46, wherein the fuel comprises a material selected from the group consisting of sodium borohydride dihydrate, potassium borohydride trihydrate, and potassium borohydride monohydrate, and mixtures thereof.

64. The method of claim 46, wherein the acidic reagent comprises a material selected from the group consisting of hydrochloric acid, sulfuric acid, phosphoric acid, acetic acid, formic acid, maleic acid, citric acid, and tartaric acid.

65. The method of claim 46, wherein the acidic reagent comprises hydrochloric acid.

66. The method of claim 65, wherein the acid has a concentration between 4.4 M and 12 M.

67. The method of claim 46, wherein the acidic reagent comprises sulfuric acid.

68. The method of claim 67, wherein the acid has a concentration between 2.6 M and 7 M.

69. The method of claim 46, further comprising dispensing solid fuel into the reaction chamber through a solid fuel dispensing means.

70. The method of claim 69, wherein the solid fuel dispensing means comprises a screw feeder, rotary star feeder, or a pellet dispenser.

71. The method of claim 46, further comprising supplying reagent through an inlet and removing reaction products through an outlet of the reaction chamber.

72. The method of claim 46, further comprising monitoring at least one of the gas pressure in the reaction chamber, the temperature in the reaction chamber, the level of materials in the reaction chamber, and power demand of a power module.

73. The method of claim 46, wherein the reaction chamber operates at a pressure of about 10 psig to about 200 psig.

74. The method of claim 46, wherein the reaction chamber operates at a pressure of about 50 psig to about 180 psig.

75. The method of claim 46, wherein a partition within the reaction chamber moves to expose at least a portion of a hydrogen separator to reaction products as the partition moves.

76. A method of operating a hydrogen device, comprising:
providing a hydrogen device having a hydrogen gas inlet;
providing a hydrogen generator having a reaction chamber and a hydrogen gas outlet in communication with the inlet of the hydrogen device;
providing a solid fuel capable of generating hydrogen and a product when brought into contact with an acidic reagent and water;
providing an acidic reagent;
contacting the acidic reagent and the solid fuel in the reaction chamber, wherein such contact generates hydrogen gas and a product having a bulk density of at least about 0.7 g/cc; and
separating the hydrogen gas from the product and conveying the gas to the inlet of the hydrogen device through the hydrogen gas outlet.

77. The method of claim 76, wherein the hydrogen device is selected from the group consisting of a fuel cell, a hydrogen-burning engine, and a hydrogen storage device.

78. The method of claim 76, wherein the hydrogen storage device is selected from the group consisting of balloons, gas cylinders, and metal hydrides.

79. The method of claim 76, wherein the hydrogen device is a power module and the reaction chamber stores hydrogen to supply demand of the power module during startup.

80. The method of claim 79, wherein the hydrogen device is a fuel cell selected from the group consisting of a PEM fuel cell, a solid oxide fuel cell, and an alkaline fuel cell.

81. The method of claim 79, further comprising generating electricity in the hydrogen device by oxidizing hydrogen.

82. The method of claim 81, further comprising transporting water generated as a product of generating electricity from the power module to the reaction chamber.

83. The method of claim 82, comprising providing a concentrated acidic reagent and adding water from the power module to the concentrated acidic reagent.

84. The method of claim 76, comprising initially providing a concentrated acidic reagent and subsequently adding water to the concentrated acidic reagent.

85. The method of claim 76, wherein separating the hydrogen comprises use of at least one hydrogen permeable membrane or filter.

86. The method of claim 76, wherein the solid fuel is a borohydride.

87. The method of claim 85, wherein the borohydride is combined with a solid stabilizer selected from the group consisting of metal hydroxides, anhydrous metal metaborates, hydrated metal borates, and mixtures thereof.

88. The method of claim 76, wherein a water soluble co-catalyst is added to the acidic reagent to further catalyze generation of hydrogen from the solid fuel.

89. The method of claim 88, wherein the co-catalyst is selected from the group consisting of the chloride salts of cobalt, nickel, and copper.

90. The method of claim 76, wherein the water concentration of the acidic reagent is about 44 M to about 52 M.

91. The method of claim 76, wherein the water concentration of the acidic reagent is about 46 M to about 50 M.

92. The method of claim 76, wherein the water concentration of the acidic reagent is about 48 M.

93. The method of claim 76, wherein the product is predominately borax pentahydrate.

94. The method of claim 76, wherein the product is predominately boric acid.

95. The method of claim 76, wherein the product has a bulk density of at least about 1.0 g/cc.

96. The method of claim 76, wherein the product is a solid.
